(19) United States
(12) Patent Application Publication
(10) Pub. No.: US 2009/0185332 A1
(43) Pub. Date: Jul. 23, 2009

(54) CASSETTE ASSEMBLY AND PANEL ASSEMBLY THEREFOR

(76) Inventors: JARROD L. COOMER, Weaverville, NC (US); MICHAEL H. ABRAHAMSEN, Greenwood, SC (US); DAVID A. METCALF, Black Mountain, NC (US); TIMOTHY FAIR, Boiling Springs, SC (US)

Correspondence Address: Martin J. Moran, 1000 Cherrington Parkway, Moon Township, PA, 15108, US

(21) Appl. No.: 12/018,587

(22) Filed: Jan. 23, 2008

(51) Int. Cl. H02B 7/00

(52) U.S. Cl. 361/605

(57) ABSTRACT

A panel assembly for an electrical enclosure has a fixed mounting portion and a movable panel portion. The electrical enclosure has an interior substantially sealed from an exterior except at a number of apertures. The panel assembly includes a mounting portion coupled to the enclosure and a panel portion generally disposed over a corresponding one of the number of apertures. The panel portion is movable in a first direction from a first position to a second position by gas formed from an arcing event within the electrical enclosure passing outward through the corresponding aperture. The panel portion is constrained from movement in an opposite second direction due to a portion of the electrical enclosure.

### BACKGROUND OF THE INVENTION

1. Field of the Invention

The invention relates generally to electrical enclosures and, more particularly, to electrical enclosures, such as cassette assemblies, for switchgear such as circuit breakers. The invention also relates to pressure relief panels for venting of high pressure gasses due to electrical arcing in electrical enclosures.

2. Background Information

Switchgear for electric power distribution systems includes electrical switching apparatus and their line and load terminations together with related equipment mounted in an electrical enclosure (typically a metal cabinet). Switchgear used in sections of electric power distribution systems operating at voltages up through 690 volts is classified as low voltage switchgear (according to international standards, although the ANSI standard for low voltage is a maximum of 600 volts). Typically, the electrical switching apparatus is a circuit breaker, but other switching apparatus such as, for example, network protectors, disconnect switches, and transfer switches are also mounted in such electrical enclosures. Henceforth, the electrical switching apparatus will generally be referred to as circuit breakers, although it will be understood that other types of electrical switching apparatus can be used as well.

Typically, in such low voltage switchgear, multiple circuit breakers are mounted in each cabinet in cells stacked vertically in a forward compartment. The line and load conductors are mounted in rearward compartments and engage the circuit breakers through quick disconnects as the circuit breakers are installed in the cells.

Some electrical switching apparatus can be relatively large. In order to facilitate movement (e.g., installation; removal; maintenance), some circuit breakers are commonly coupled to draw-out mechanisms which permit such circuit breakers to be drawn out of the electrical enclosure. Accordingly, such circuit breakers are commonly known in the art as “draw-out” circuit breakers. Draw-out circuit breakers are described in further detail, for example, in commonly assigned U.S. Pat. No. 7,019,229, which is hereby incorporated herein by reference. See also U.S. Pat. Nos. 4,002,864; 4,002,865; 4,017,698; 4,728,757; 6,031,192; and 6,563,062.

The electrical enclosure for draw-out circuit breakers generally includes an outer structure having a top, a bottom, rear and side walls, and a front access door or easily removable panel.

Circuit breakers are designed to trip in response to a trip condition (e.g., without limitation, an overcurrent condition; an overload condition; a relatively high level short circuit or fault condition). A high current fault interruption, for example, typically results in a substantial arc in the arc chamber of the circuit breaker. The arc forms rapidly expanding gases, and may generate flames and flying debris comprised of molten metal particles and fragments of various circuit breaker components.

Similar arcing can occur between adjacent conductors of different potentials, between an outboard line or load conductor and the switchgear cabinetry, and between the quick disconnects that are electrically connected with the line and load conductors. Such arcing events are generally of greater magnitude and duration than those produced from fault interruption due to tripping of a circuit breaker. Such potential arcing events could result from a number of different scenarios such as, but not limited to: an operator leaving a tool in the switchgear prior to energizing the switchgear, an operator leaving a tool (or other object) on the back of a circuit breaker while racking the breaker onto a live bus, buildup of debris within the switchgear, animals entering the switchgear through venting holes and crossing a live bus, or some other type of unforeseen failure within the switchgear. Severe injury/damage can occur to an operator or other person(s) and equipment nearby if the electrical enclosure is not designed to manage the large volumes of gas and debris formed from such an arcing event. While known enclosure designs provide vents through which arc gases may pass, such vents are typically designed primarily for cooling of the interior of the enclosure and as such do not provide much, if any, control over potential arc gas venting, particularly not of large scale arc gas formations.

There is, therefore, room for improvement in electrical enclosures and how they manage large scale arcing events and particularly the large volumes of gas formed. There is also room for improvement of the mechanisms needed for use in such a system.

### SUMMARY OF THE INVENTION

These needs and others are met by embodiments of the invention, which are directed to a pressure relief panel assembly for an electrical enclosure housing an electrical switching apparatus, such as a draw-out circuit breaker.

In accordance with one aspect of the invention, a panel assembly is provided for an electrical enclosure comprising a housing. The housing includes a plurality of walls having a number of apertures therein. The housing defines an interior and an exterior, the exterior being substantially sealed from the interior except at the number of apertures. The panel assembly comprises a mounting portion and a panel portion that extends from the mounting portion. The mounting portion is structured to be coupled to one of the walls of the housing at or near a corresponding one of the number of apertures such that the panel portion substantially covers the corresponding one of the number of apertures. The panel portion is movable generally in a first direction from a first position to a different second position relative to the mounting portion. The panel portion is structured to be generally restricted from movement in a second direction generally opposite the first direction by a portion of the housing.

The interior of the housing may include a number of electrical conductors and a pressurized gas formed from an arcing event involving the number of electrical conductors. The panel assembly may be structured to vent the pressurized gas from the interior of the electrical enclosure by moving from the first position to the different second position.

The panel portion may include a number of tabs coupling the panel portion to the mounting portion. Such tabs may be disposed along opposing edges of the panel portion. Such tabs may also be disposed along two adjacent edges of the panel portion. The mounting portion and panel portion may be formed from a single piece of material such that the panel portion and the mounting portion are different portions of the single piece of material. The single piece of material may be a metal or it may be an insulative material. Movement of the panel portion from the first position to the different second position may result from flexure or fracture of the number of tabs.

As another aspect of the invention, a cassette assembly structured to be housed in an electrical enclosure is provided. The cassette assembly comprises a top panel, a bottom panel, a pair of side walls, a front access panel, and a rear panel having a number of apertures therein. The top panel, bottom panel, pair of sidewalls, front access panel, and rear panel define an interior substantially sealed from an exterior except at the number of apertures. A number of panel assemblies as previously described are disposed over corresponding ones of the number of apertures of the rear panel.

The interior may include a number of electrical conductors and a pressurized gas formed from an arcing event involving the number of electrical conductors. The number of panel assemblies may be moved from the first position to the different second position by the pressurized gas passing through the corresponding number of apertures. The pressurized gas passing through the number of apertures may be directed generally toward a top panel of the electrical enclosure by the number of panel assemblies positioned in the different second position.

### BRIEF DESCRIPTION OF THE DRAWINGS

A full understanding of the invention can be gained from the following description of the preferred embodiments when read in conjunction with the accompanying drawings in which:

FIG. 1 is a partially exploded isometric view of an electrical cabinet assembly including cassette assemblies in accordance with embodiments of the invention;

FIG. 2 is an isometric view of the electrical cabinet assembly of FIG. 1 with a rear portion removed to show internal structures;

FIG. 3 is an isometric view of a portion of plural cassette assemblies including a panel assembly in accordance with an embodiment of the invention;

FIG. 4 is an isometric view of the portion of the plural cassette assemblies of FIG. 3 with an additional panel assembly in accordance with another embodiment of the invention; and

FIGS. 5-8 are isometric views of panel assemblies for cassette assemblies in accordance with other embodiments of the invention.

### DESCRIPTION OF THE PREFERRED EMBODIMENTS

As employed herein, the term “number” shall mean one or an integer greater than one (i.e., a plurality).

Directional phrases used herein, such as, for example, left, right, front, back, top, bottom and derivatives thereof, relate to the orientation of the elements shown in the drawings and are not limiting upon the claims unless expressly recited therein.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

As employed herein, the term “circuit breaker” refers to an electrical circuit breaker that may be drawn into and out of an enclosure (e.g., without limitation, switchgear cabinet), in which it is housed. Such a circuit breaker is also referred to as a “draw-out circuit breaker.” A draw-out mechanism (e.g., without limitation, rollers; rails having linear bearings) facilitates the movement of the draw-out circuit breaker into and out of the enclosure.

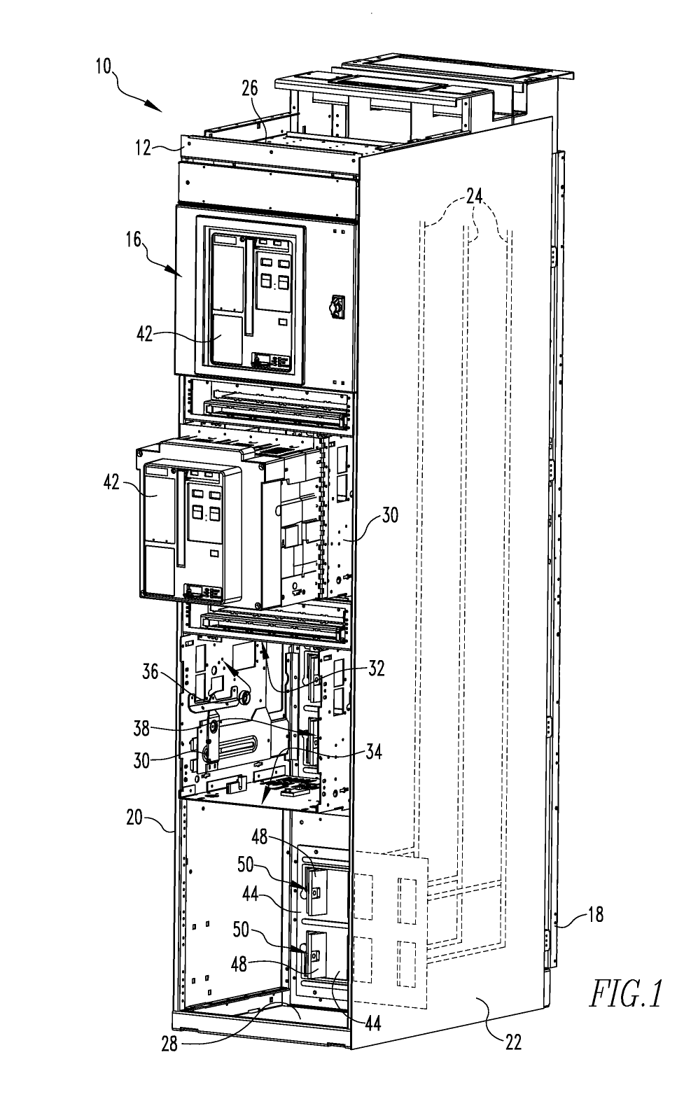

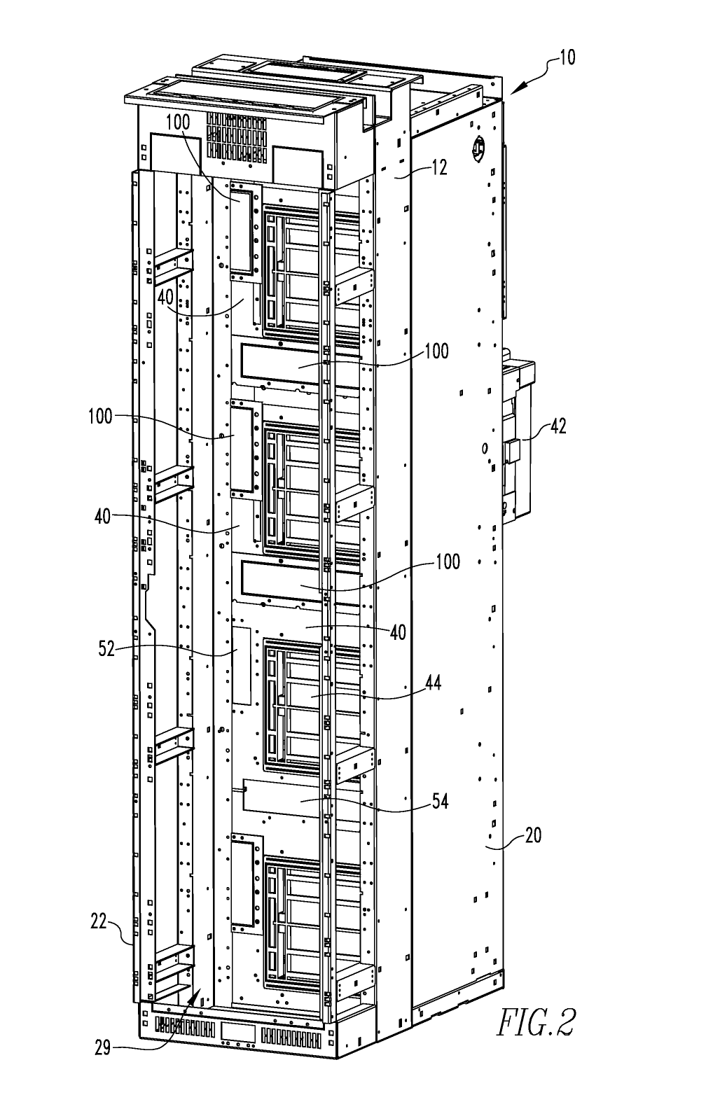

FIGS. 1 and 2 show an electrical cabinet assembly 10 utilizing examples of the panel assembly 100 of the present invention. A complete electrical cabinet assembly may contain one or more of the following combination of parts described herein. The example electrical cabinet assembly 10 includes an electrical enclosure 12 (e.g., without limitation, a switchgear cabinet) having an interior and an exterior defined by a front opening (not numbered) generally covered by a removable access panel(s) (not shown) or door(s) 16 (FIG. 1), a rear panel 18, a left side panel 20, a right side panel 22, a top panel 26 and a bottom 28. The interior of the electrical enclosure 12 is generally divided into a bus compartment 29 (FIG. 2) and a number of cassettes 30 (FIG. 1). A number of conductors 24 (shown in simplified form in hidden line drawing in FIG. 1) are housed within the bus compartment 29 (FIG. 2) of the electrical enclosure 12.

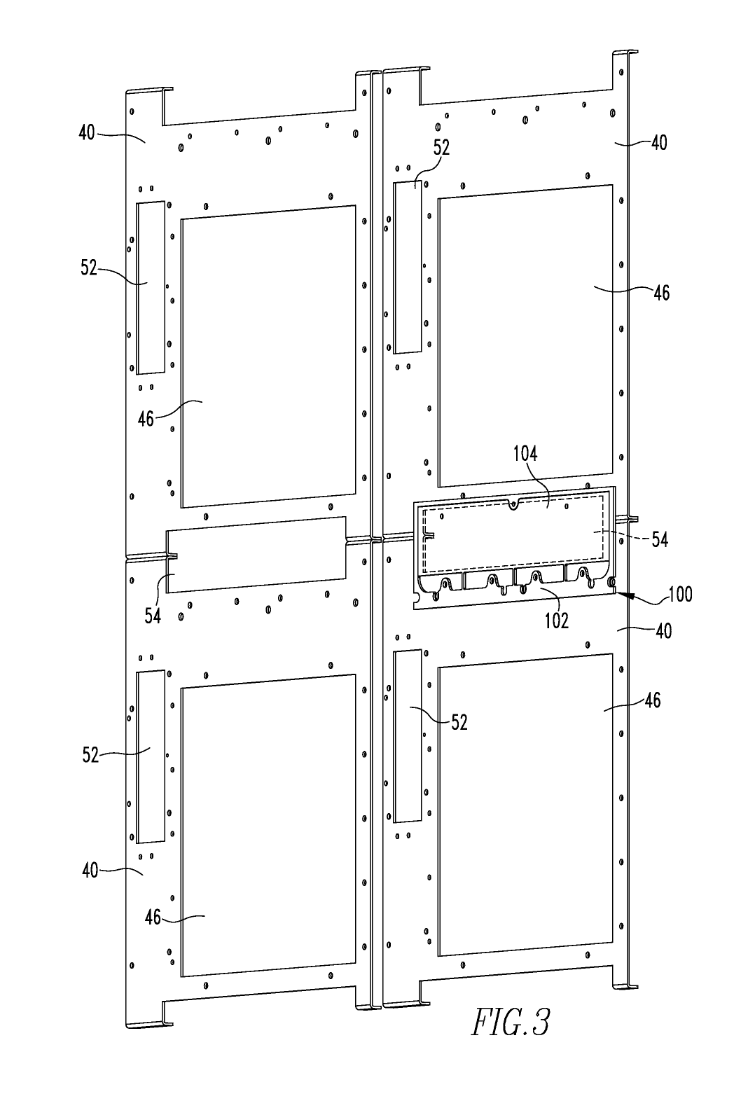

Each cassette 30 has an interior (not numbered) substantially sealed from the interior of the electrical enclosure 12 as well as from each of the other cassettes 30. The interior of each cassette 30 is defined by a top panel 32, a bottom panel 34, a left side panel 36, a right side panel 38, a rear panel 40 (FIGS. 2 and 3) and a door 16 of the electrical enclosure 12. Although the example enclosure 12 shown in FIG. 1 includes three cassettes 30 (2 numbered, and a top cassette not numbered as it is behind door 16) installed therein and one additional location at the base of the enclosure where an additional cassette 30 could be installed, it can be appreciated that any suitable number of cassettes 30 may be employed. As shown in FIGS. 3 and 4, rear panel 40 includes a relatively large opening 46 in which a stab support panel 44 (shown in FIGS. 1 and 2) is installed. The stab support panel 44 is formed from an insulating material and provides support to a number of stabs 48 (FIG. 1) formed from a conductive material that pass through stab support panel 44. Each of the number of stabs 48 has a first end (not numbered) extending from the support panel 44 away from the cassette 30 and a second end 50 extending from the support panel 44 into the interior of the cassette 30. Each stab 48 is electrically coupled generally at or near its first end to a corresponding one of the number of conductors 24.

Rear panel 40 of cassette 30 further includes a first aperture 52, preferably of generally rectangular shape. As best shown in FIG. 3, two adjacent rear panels 40 of the same electrical enclosure 12 may also form a second aperture 54 also of generally rectangular shape. It is to be appreciated that FIGS. 3 and 4 show a total of four rear panels 40 arranged for example and comparative purposes only and are not intended to limit the invention to a particular arrangement of panels. Such an arrangement as shown in FIGS. 3 and 4 could correspond to a total of four cassettes 30 in two side-by-side electrical enclosures 12, with each electrical enclosure 12 having two cassette 30 stacked one above the other. It is to be further appreciated, that while second aperture 54 is shown to be formed by two separate rear panels 40, such second aperture 54 may be formed within a single rear panel 40 (similar to aperture 52). It is to be appreciated that the interior (not numbered) of cassette 30 is substantially sealed from both the bus compartment 29 (FIG. 2) as well as the other cassettes 30, except at the first and second apertures 52,54.

As shown in FIG. 1, housed within each cassette 30 is a circuit breaker 42 having a number of primary disconnects (not shown) disposed on a rear portion (not numbered) thereof. When housed within a cassette 30, circuit breaker 42 is generally movable a distance (not shown) between a first, racked-out position (as shown by the second circuit breaker 42 from the top of FIG. 1) in which the number of primary disconnects on the rear of the circuit breaker 42 are spaced from the second ends 50 of the number of stabs 48 and a second, racked-in position (as shown by the uppermost circuit breaker 42 of FIG. 1) in which the primary disconnects on the rear portion of the circuit breaker 42 are in electrical contact with the second ends 50 of the number of stabs 48. Movement of the circuit breaker 42 between the racked-out and racked-in positions may be carried out through the use of a conventional draw out mechanism (not shown).

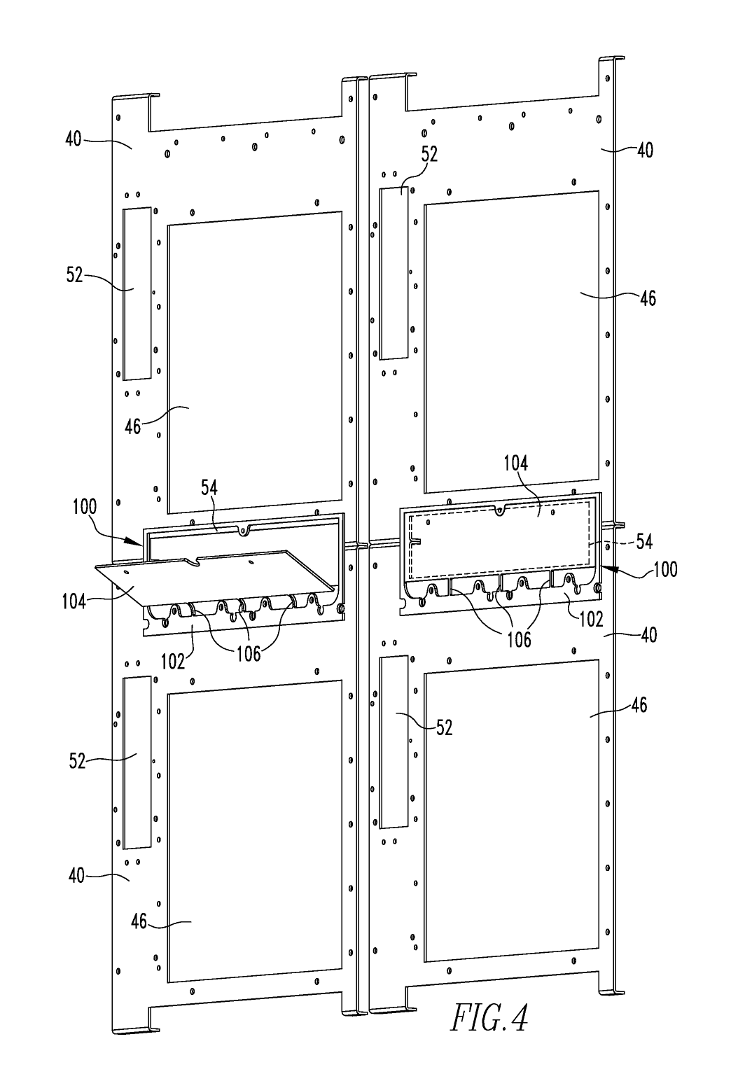

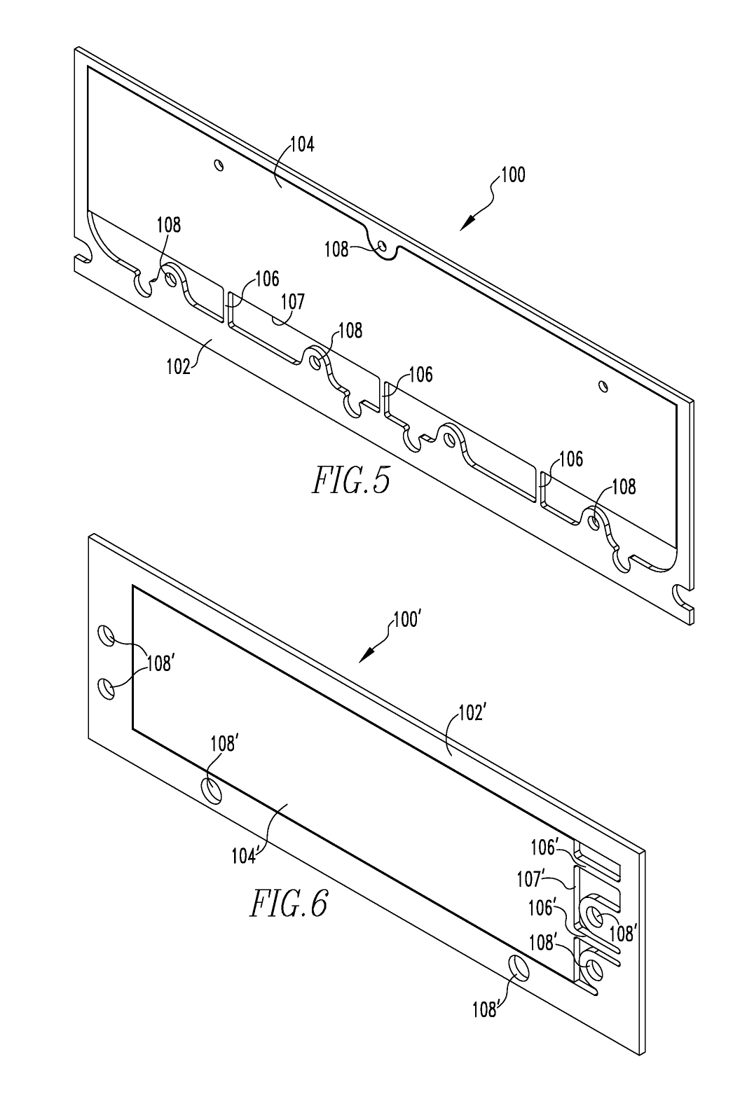

As shown in FIG. 2, coupled to the rear panel 40 at each of the first and second apertures 52,54 are panel assemblies 100 which may be of the same or different design dependent on location. FIGS. 5-8 show some examples of such panel assemblies that may be utilized.

Referring to FIG. 5, panel assembly 100 (see, also, similar panel assembly 100′ of FIG. 6) is preferably formed from a single, generally flat, piece of material (e.g., without limitation, a metal) and includes a mounting portion 102 coupled to a panel portion 104 via a number of tabs 106 located along a side 107 of the panel portion 104. Mounting portion 102 includes a number of mounting holes 108 that can be utilized in coupling panel assembly 100 to rear panel 40 such as shown in FIGS. 3 and 4. Panel portion 104 is preferably of dimensions slightly larger than that of the corresponding one of the first and second apertures 52,54 of FIGS. 3 and 4. As best shown in FIG. 3, when panel assembly 100 is coupled to rear panel 40, the panel portion 104 is positioned such that the underlying aperture (54 in FIG. 3) is completely or at least nearly completely covered. It is to be appreciated that when door 16 (FIG. 1) (or equivalent access panel) is secured to the cassette 30 (FIG. 1) in the closed position and panel assemblies 100 are disposed over the corresponding first and second apertures 52, 54, that the interior (not numbered) of the cassette 30 is substantially sealed from both the bus compartment 29 as well as the other cassettes 30.

As shown in FIG. 4, tabs 106 are structured to bend thus permitting the panel portion 104 of the panel assembly 100 to be displaced in a first pivotal direction from a first position (as shown on the right portion of FIG. 4) in which the panel portion 104 substantially covers the underlying aperture 54 to a second position (as shown on the left portion of FIG. 4) in which the panel portion 104 is moved generally away from the aperture 54 and mounting portion 102. Movement of the panel portion 104 in a direction opposite the first direction is generally restricted by one or more of the edges of the underlying aperture 54 that is of slightly smaller dimensions than the overlying panel portion 104. It will be appreciated that the panel assembly 100 may be similarly applied to any or all of the other apertures 52,54. Movement of the panel portion 104 in the first direction can result from the interior of the cassette 30 (FIG. 1) becoming positively pressurized relative to the exterior of the cassette 30 (e.g., bus compartment 29). Increased pressure in the cassette 30 may result from large volumes of gas produced by an arcing event (e.g., without limitation, an electrical short) involving one or more of the stabs 48 (FIG. 1) electrically coupled to the number of conductors 24 (FIG. 1). The increase in pressure within the cassette 30 cause gases to be forced through the first and second apertures 52, 54. Such gases then can force the panel portions 104 of panel assemblies 100 to move from the closed position (as shown in the left portion of FIG. 4) to an open position (as shown in the right portion of FIG. 4). Such movement of panel portions 104 away from aperture 54 allows the volume of gas generated by the arcing event within the cassette 30 to generally vent from the cassette through the aperture 54. It is to be appreciated that the orientation of the panel assembly 100 (as well as the underlying aperture 52,54) may be varied as desired to help direct the venting gases in a desired direction (in the example shown in FIG. 4, the gases would tend to be directed upward). Additionally, the force required to move the panel portion 104 may be varied by changing the material from which the panel assembly 100 is fabricated or by varying the dimensions of the panel assembly (e.g., without limitation, the number and/or dimensions of the tabs 106; dimensions of panel portion 104). Preferably the panel assembly 100 is made from steel, however the panel assembly 100 could also be made from other materials (e.g., without limitation, aluminum or plastic).

FIG. 6 shows another example of a panel assembly 100′ of similar construction and function to panel assembly 100 shown in FIG. 5. Like the example of FIG. 5, the panel assembly 100′ of FIG. 6 is preferably formed from a single, generally flat, piece of material (e.g., without limitation, a metal) and includes a mounting portion 102′ coupled to a panel portion 104′ via a number of tabs 106′ located along a side 107′ of the panel portion 104′. Mounting portion 102′ includes a number of mounting holes 108′ that can be utilized in coupling panel assembly 100′ to rear panel 40. Panel portion 104′ is preferably of dimensions slightly larger than that of the corresponding one of the first and second apertures 52,54 (FIG. 3). As with the example of FIG. 5, the example of FIG. 6 is movable through bending of the tabs 106′.

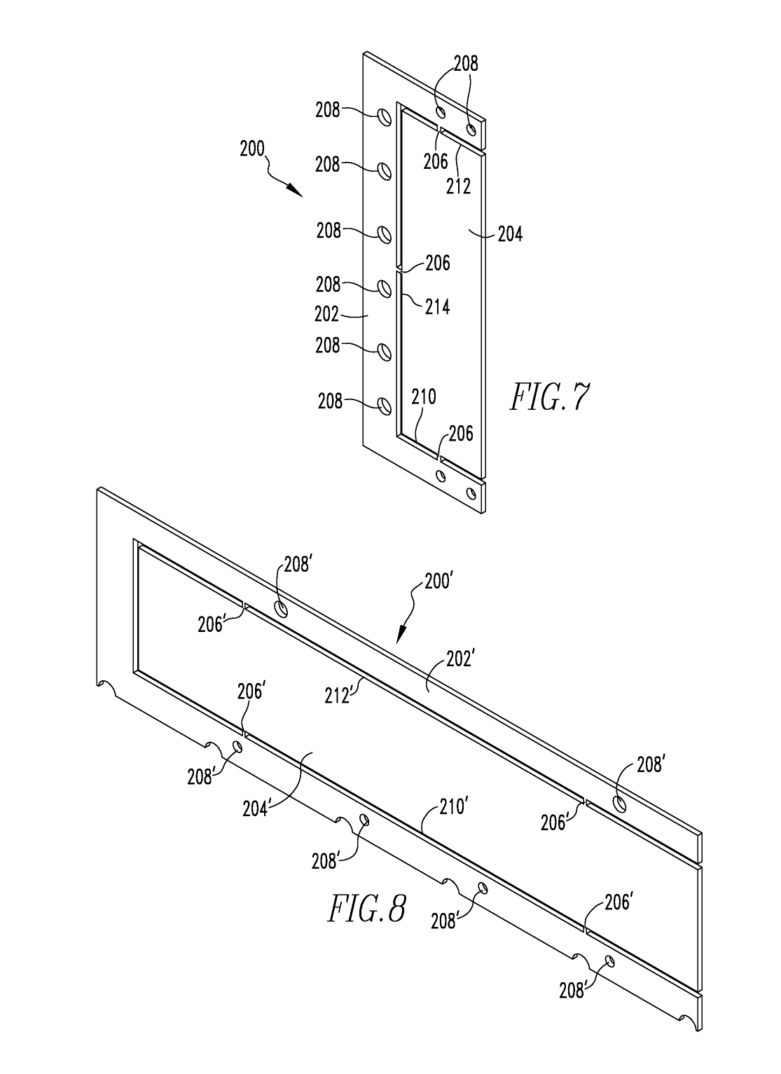

FIGS. 7 and 8 show further examples of panel assemblies 200, 200′ that may be coupled at a corresponding one of the apertures 52,54 (FIG. 3) in place of the preceding examples. Like the previous examples, the panel assemblies 200,200′ of FIGS. 7 and 8 are preferably formed from a single, generally flat, piece of material and include a mounting portion 202,202′ coupled to a panel portion 204,204′ via a number of tabs 206,206′. The mounting portion 202,202′ includes a number of mounting holes 208,208′ that can be utilized in coupling panel assembly 200,200′ to rear panel 40. Unlike the previous examples, mounting tabs 206,206′ coupling the panel portion 204,204′ to the mounting portion 202,202′ are disposed along more than one edge of the panel portion 204. The example of FIG. 7 shows mounting tabs disposed along three consecutive sides 210,212,214 of panel portion 204. The example of FIG. 8 shows mounting tabs disposed along two opposing sides 210′, 212′ of panel portion 204′. Panel assembly 200 is preferably made from an insulative material (e.g., without limitation, a thermoset fiberglass-reinforced polyester, glastic) but could also be made from other materials (e.g., without limitation, plastic or urethane).

Like the previously discussed panel assemblies 100,100′, when coupled to rear panel 40 (FIG. 3) at one of the apertures 52,54 (FIG. 3), the panel portion 204,204′ of panel assembly 200,200′ is movable, in response to a pressure increase due to an arcing event as previously described, in a first direction from a first position in which the panel portion 204,204′ substantially covers the underlying aperture (52 or 54), to a second position in which the panel portion 204,204′ does not cover the aperture. Unlike the previous examples of FIGS. 5 and 6, however, movement of the panel portion 204,204′ does not occur via bending of the tabs 206,206′ but instead occurs via fracture of at least some of the tabs 206,206′ so that the panel portion 204,204′ becomes partially, or completely detached from mounting portion 202,202′. Once panel portion 204,204′ has become partially, or completely detached, gas within the cassette 30 (FIG. 1) may vent from the corresponding aperture (52 or 54). Movement of the panel portion 204,204′ in a direction opposite the first direction is generally restricted by one or more of the edges of the underlying aperture (52,54) that is of slightly smaller dimensions than the overlying panel portion 204,204′.

Similar to the panel assemblies 100,100′ previously discussed, the amount of pressure required to fracture the tabs 206,206′ and displace the panel portion 204,204′ may be varied by changing the material from which the panel assembly 200,200′ is fabricated or by varying the dimensions of the panel assembly (e.g., without limitation, the number and/or dimensions of the tabs 206,206′; dimensions of panel portion 204,204′).

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A panel assembly for an electrical enclosure, said electrical enclosure comprising: a housing including a plurality of walls having a number of apertures therein, said housing defining an interior and an exterior, said exterior being substantially sealed from said interior except at said number of apertures, said panel assembly comprising:
a mounting portion; and
a panel portion extending from said mounting portion;
wherein said mounting portion is structured to be coupled to one of the walls of said housing at or near a corresponding one of said number of apertures in order that said panel portion substantially covers said corresponding one of said number of apertures; wherein said panel portion is movable in a first direction from a first position to a different second position relative to said mounting portion; and wherein said panel portion is structured to be restricted from movement in a second direction opposite said first direction by a portion of said housing.

2. The panel assembly of claim 1, wherein said interior includes a number of electrical conductors and a pressurized gas formed from an arcing event associated with said number of electrical conductors; and wherein said panel assembly is structured to vent said pressurized gas from the interior of said electrical enclosure by moving from said first position to said different second position.

3. The panel assembly of claim 2, wherein said panel portion includes a number of tabs coupling said panel portion to said mounting portion; wherein said mounting portion and said panel portion are formed from a single piece of material; and wherein said panel portion and said mounting portion are different portions of said single piece of material.

4. The panel assembly of claim 3, wherein movement of the panel portion from said first position to said different second position results from flexure of said number of tabs.

5. The panel assembly of claim 4, wherein said single piece of material is made of a metal.

6. The panel assembly of claim 3, wherein said number of tabs are disposed along opposing edges of said panel portion; and wherein movement of the panel portion from said first position to said different second position results from fracture of said number of tabs.

7. The panel assembly of claim 6, wherein the panel assembly is made of an insulative material.

8. The panel assembly of claim 7, wherein said insulative material is a thermoset fiberglass-reinforced polyester.

9. The panel assembly of claim 3, wherein said number of tabs are disposed along two adjacent edges of said panel portion; and wherein movement of the panel portion from said first position to said different second position results from fracture of said number of tabs.

10. A cassette assembly structured to be housed in an electrical enclosure, said cassette assembly comprising:
a top panel;
a bottom panel;
a pair of side walls;
a front panel;
a rear panel having a number of apertures therein, said top panel, said bottom panel, said pair of sidewalls, said front panel, and said rear panel define an interior substantially sealed from an exterior except at said number of apertures;
a number of panel assemblies, each of said number of panel assemblies being disposed over a corresponding one of the number of apertures of said rear panel, each of said number of panel assemblies comprising:
a mounting portion coupled to said rear panel at or near a corresponding one of said number of apertures; and
a panel portion extending from said mounting portion;
wherein said panel portion is movable in a first direction from a first position to a different second position relative to said mounting portion; and
wherein said panel portion is structured to be restricted from movement in a second direction opposite said first direction by a portion of said rear panel.

11. The cassette assembly of claim 10, wherein said interior includes a number of electrical conductors and a pressurized gas formed from an arcing event associated with said number of electrical conductors; and wherein at least one of said number of panel assemblies is moved from said first position to said different second position by said pressurized gas passing through a corresponding one of said number of apertures.

12. The cassette assembly of claim 11, wherein said panel portion includes a number of tabs coupling said panel portion to said mounting portion; wherein said mounting portion and said panel portion are formed from a single piece of material; and wherein said panel portion and said mounting portion are different portions of said single piece of material.

13. The cassette assembly of claim 12, wherein movement of the panel portion from said first position to said different second position results from flexure of said number of tabs.

14. The cassette assembly of claim 13, wherein said single piece of material is made of a metal.

15. The cassette assembly of claim 12, wherein said number of tabs are disposed along opposing edges of said panel portion; and wherein movement of the panel portion from said first position to said different second position results from fracture of said number of tabs.

16. The cassette assembly of claim 15, wherein the panel assembly is made of an insulative material.

17. The cassette assembly of claim 15, wherein said insulative material is a thermoset fiberglass-reinforced polyester.

18. The cassette assembly of claim 11, wherein said electrical enclosure includes a top panel; and wherein said pressurized gas is directed generally toward said top panel by said number of panel assemblies positioned in said different second position.

19. The cassette assembly of claim 12, wherein said number of tabs are disposed along two adjacent edges of said panel portion; and wherein movement of the panel portion from said first position to said different second position results from fracture of said number of tabs.

20. The cassette assembly of claim 12, wherein said number of tabs are disposed along two adjacent edges of said panel portion and two opposing edges of said panel portion; and wherein movement of the panel portion from said first position to said different second position results from fracture of said number of tabs.
